(19) United States
(12) Patent Application Publication
(10) Pub. No.: US 2004/0137877 A1
(43) Pub. Date: Jul. 15, 2004

(54) Security system

(76) Inventors: Peter Crowhurst, Melbourne (AU); Gianfranco Pavatich, Melbourne (AU)

Correspondence Address: KENYON & KENYON, ONE BROADWAY, NEW YORK, NY, 10004, US

(21) Appl. No.: 10/356,916

(22) Filed: Feb. 3, 2003

Related U.S. Application Data
(63) Continuation of application No. 10/111,610, now abandoned.
Application No. 10/111,610 is a 371 of international application No. PCT/DE01/02534, filed on Jul. 7, 2001.

(30) Foreign Application Priority Data
Aug. 25, 2000 (AU) PQ 9682

(51) Int. Cl. H04M 1/66

(52) U.S. Cl. 455/411

(57) ABSTRACT

A security system (4, 8), including an electronic key (4) having a transmitter (6) and a secure object having a base station (8) which has a receiver (10) is described, the transmitter (6) and the receiver (10) being designed so that they communicate to exchange authentication data, the key (4) transmitting the data in a message which includes parts having predetermined periods (T0, . . . , T4) having transmission signal variations; and the base station (8) detecting distortion in the transmission signal variations due to a relay station.

The present invention relates to a security system, in particular a passive security system for vehicles.

Current passive security systems for access to or activation of vehicles use a remote-operated electronic key, which includes a transmitter which transmits authentication data to a receiver located in the vehicle when a transponder of a key is energized when the key is within a predetermined range of the receiver. The communications protocol activated between the transmitter and the receiver uses a radio frequency interface to carry the transmitted data as well as any data sent from the vehicle to the key. The radio frequency (RF) interface has a limited range to ensure the communications link is interrupted when a person holding the key moves away from the immediate vicinity of the vehicle.

Passive security systems are susceptible to attack from unauthorized persons using intercepting equipment set up in the vicinity of the vehicle and the key. Such a device is used to energize the key, to receive the transmissions sent by the key and to relay the transmissions to the vehicle. The intercepting equipment, which is often referred to as a relay station, normally includes a receiver and an amplifier placed within range of the key to transmit the intercepted signal to a receiver and an amplifier in the vicinity of the vehicle to gain access to the vehicle.

The specifications of Australian Patent Applications 33933/99 and 42419/99, referred to below as “the two-tone security system specifications” and incorporated into this description by this reference, describe security systems that may be used to prevent or to detect attacks by relay stations when the relay station uses a wide-and amplifier to intercept signals transmitted between the key and the vehicle using a number of different RF transmission channels. It is possible to detect the relay station by using a two-tone test as described in both of the two-tone security system specifications cited above.

However, it is possible for a relay station to use equipment which does not include a wide-band amplifier, but instead uses separate receivers, filters and amplifiers for each transmission channel. The relay station may have separate transmitter/receiver stations, each equipped with a receiver and a transmitter, dedicated to each radio frequency channel in the frequency band in which the passive security system is operated. Then the relay station would not have to scan the frequency band of the security system to locate the channels, both of which are used for spectral authentication of the data and transponders. In this scenario, the two-tone test cannot be used to detect the sideband intermodulation produced by the intercepting wide-band amplifier in mixing the transmission channels. Accordingly, it is desirable to provide a security system which may be used to prevent this type of attack or at least provide an expedient alternative.

The present invention provides a security system, including an electronic key having a transmitter and a secure object having a base station which has a receiver, the transmitter and the receiver being designed so that they communicate to exchange authentication data, wherein the key which transmits the data in a message includes parts having predetermined periods having transmission signal variations; and the base station detects distortion in the transmission signal variations due to a relay station.

The present invention also relates to a communication method which is implemented by a security system, including an electronic key having a transmitter and a secure object having a base station which has a receiver, the method including the transmission of authentication data from the transmitter to the receiver, characterized by transmission of data in a message which includes parts having predetermined periods having transmission signal variations, and detection at the base station of distortion in the transmission signal variations due to a relay station.

A preferred implementation of the present invention is described below merely as an example with reference to the accompanying drawing.

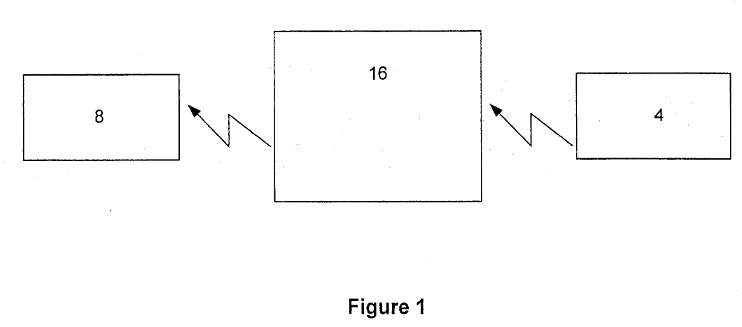

FIG. 1 is a schematic diagram of a preferred implementation of a security system having a relay station;

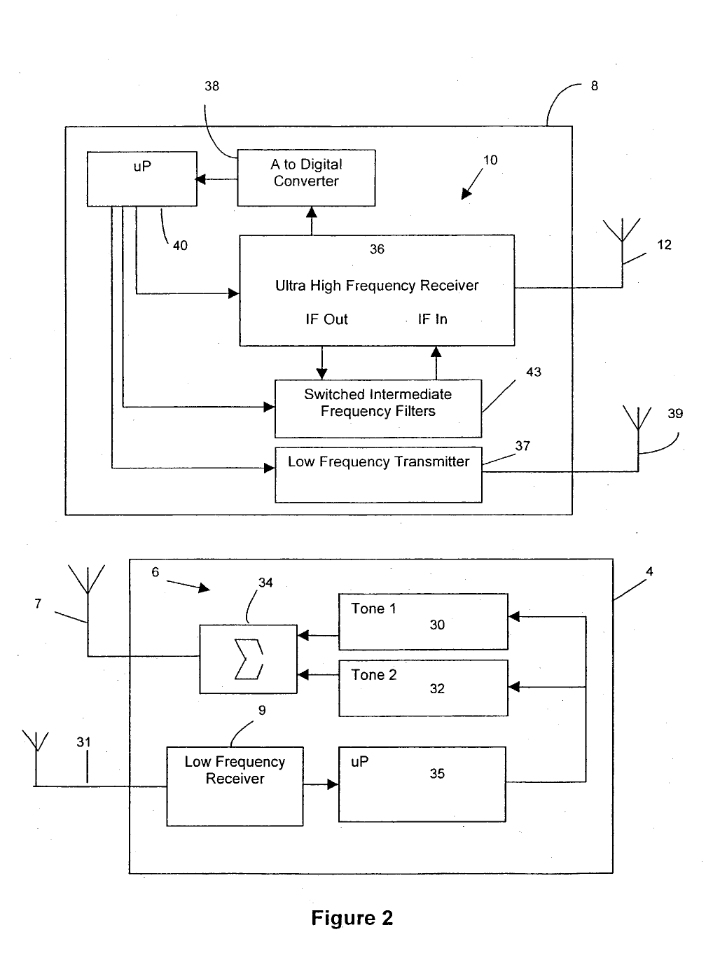

FIG. 2 is a block diagram of a security system;

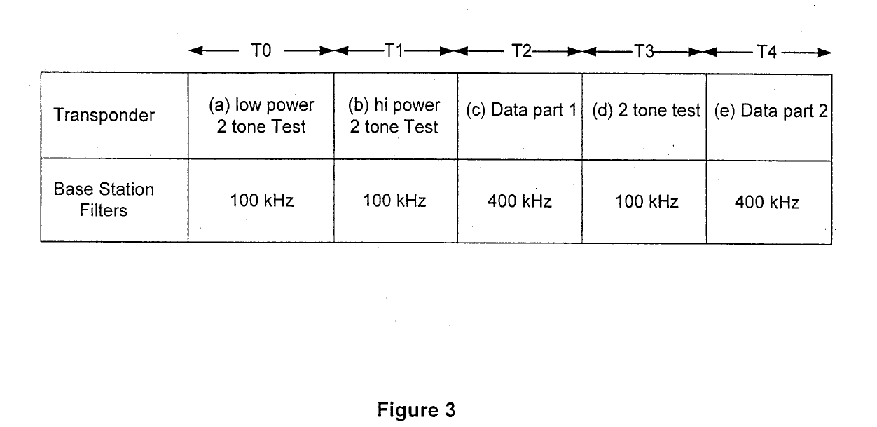

FIG. 3 is a timing diagram for signals transmitted by the security system;

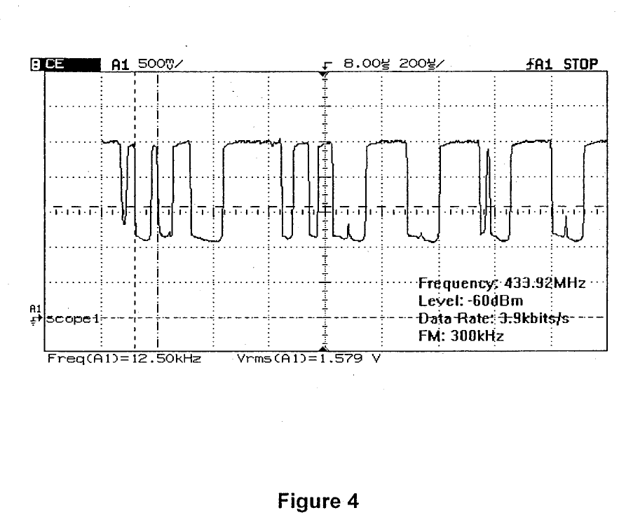

FIG. 4 is a diagram of a corrupted data signal;

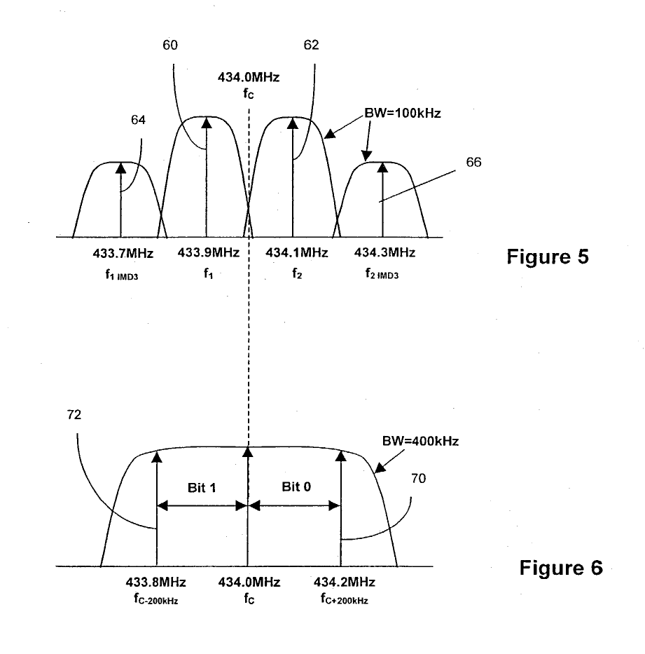

FIG. 5 is a diagram of a frequency spectrum for two-tone transmission of the system; and

FIG. 6 is a diagram of a frequency spectrum for data transmission of the system.

A passive security system, as shown in FIGS. 1 and 2, includes an electronic key 4 having a transmitter 6 and a sending antenna 7, a base station 8 having a receiver 10 and a receiving antenna 12. Base station 8 is located in a secure location, such as a vehicle, and controls access to the secure location and/or starting of the vehicle. When key 4 is brought within a certain range of antenna 12 of receiver 10, receiver 10 energizes the transponder of key 4, thus causing transmitter 6 to begin transmission to receiver 10. Data is transmitted using RF signals which establish a communications link between key 4 and base station 8. The data transmitted between key 4 and base station 8 is determined by a communications protocol which key 4 and base station 8 adhere to and which includes the transmission of authentication data from key 4 to receiver 10. Access to the secure area and/or starting the vehicle is allowed by base station 8 only if the transmitted authentication data matches the authentication data stored by base station 8.

Key 4 and base station 8 include a number of security features, such as those described in the two-tone security system specifications. The components of key 4 and base station 8 are the same as those described in the two-tone security system specifications, except that transmitter 6 of key 4 and receiver 10 of base station 8 include additional filters having larger bandwidths, as described below, or programmable filters whose bandwidths are adjustable. The control software in key 4 and base station 8 is also adjusted so that the communications protocol is executed as described below with reference to FIG. 3.

Key 4 includes a microcontroller 35, which includes the control software for controlling the key components as part of the communications protocol. Microcontroller 35 controls transmitter 6, which includes a first oscillator 30 to generate a first fundamental tone 60 and a second oscillator 32 to generate a second fundamental tone 62. The frequency signals generated are combined by a combiner (antenna switch) or integrating amplifier 34 for transmission on UHF sending antenna 7. Microcontroller 35 is also connected for controlling oscillators 30 and 32, so that it is capable of producing a frequency shift or a frequency deviation, supported on the data to be transmitted, as described below. Microcontroller 35 is also capable of receiving control data from base station 8 over a low-frequency receiver 9 and antenna 31. Key 4 includes a transponder circuit arrangement (not shown) to energize or trigger key 4 when it is within a predetermined range of base station 8. Within this range, an energization signal may be generated by the vehicle when a certain event occurs, e.g., lifting the door handle or the like. As soon as key 4 is energized or activated, communications protocol 4 for access authorization to the vehicle is activated.

Base station 8 includes a microcontroller 40 which has control software and controls operation of the components of base station 8. These parts include a UHF receiver 36, which is connected to receiving antenna 12 to provide an output of data received for microcontroller 40.

An analog-to-digital converter 38 is used to convert analog output signals of receiver 36 into digital form for microcontroller 40. These signals include an RSSI (input signal strength indicator) output which supplies spectral signature data for microcontroller 40. Intermediate-frequency signals, generated by receiver 36, are relayed to filter 43 for filtering and then are sent back to receiver 36 to blank out the data carried by the signals. Filters 43 are switched intermediate-frequency filters having bandwidths which are set by microcontroller 40 in accordance with the protocol. Base station 8 also has a low-frequency transmitter 37 and antenna 39 for transmission of data from microcontroller 40 to key 4. Low-frequency transmitter 37, antennas 31 and 39 and receiver 9 of key 4 are designed so that a low-frequency communications link is established only when key 4 and base station 8 are accommodated jointly within the secure area, e.g., inside the vehicle. For example, sending antenna 39 may be in the form of a coil which is accommodated in ignition barrel 39, so that a connection to antenna 31 is established only when key 4 is inserted into the ignition switch of the ignition system. The low-frequency channel connection is used to send synchronization control data from the base station to key 4 for use the next time key 4 is energized. The synchronization control data is used to set times T0, T1, T2, T3 and T4 for the various parts or components of the messages sent in the access authorization protocol.

The protocol shown in FIG. 3, beginning at steps (a) and (b), includes the two fundamental tones with a 100 kHz interval sent by key 4, first at a low power and then at a high power, and performing the two-tone test, as described in the two-tone security system specifications. FIG. 5 shows an example of the frequency spectrum of the signals received by receiver 10 during two-tone transmissions. For example, if fundamental tone oscillators 30 and 32 are set to transmit 433.9 MHz and 434.1 MHz, then all third-order intermodulation distortion products will appear at frequencies 433.7 MHz and 434.3 MHz, 64 and 66, respectively. Microcontroller 40 sets filter 43 so that corresponding bandwidth filters with a width of 100 kHz are provided for each frequency 60, 62, 64 and 66. The spectral information within these bands is converted to a spectral signature for microcontroller 40 and compared with the stored spectral mask to detect interference at each relay station 16 according to the two-tone test.

The ability to recognize a relay station by the two-tone test is maximized by synchronized switching of the low-power and high-power transmission parts (a) and (b) of the message transmitted. The distortion products introduced into the intermodulation bands by a relay station 16 are tripled for each individual increase in power. During the initial transmission part (a) in a low power, one relay station 16 would have to send a considerable power gain to its amplifiers to bridge the distance between key 4 and base station 8 of the vehicle. When key 4 begins to transmit the high-power component (b) by increasing the power gain of amplifier 34 at a synchronization time which is specified by base station 8, relay station 16 is not capable of equalizing the power gain of its amplifiers immediately, and an exaggeratedly amplified signal is transmitted to receiver 10. If, for example, key 4 introduces a power increase of 30 dB at the end of period T0, then the distortion products in the intermodulation bands are increased by 90 dB. This guarantees that in unfavorable circumstances, when the intermodulation products would otherwise be within the noise floor of receiver 10, these products would be raised to a power level to ensure that they are within the measurement range of receiver 10.

In step (c), the authentication data to be transmitted between the base station and the key is sent in a first part. However, it is sent using frequency shift keying and applying a frequency deviation, e.g., 200 kHz, from the selected transmission channel. In other words, a low signal 70 is sent with a +200 kHz deviation, and a higher signal 72 is sent with a −200 kHz deviation. FIG. 6 shows the frequency spectrum of the signals received by receiver 10 during fsk data transmission. Since filters 43 of receiver 10 have first been set to a bandwidth of 100 kHz, they must be equalized to prevent corruption of data. Accordingly, during an initial transmission, e.g., before or during the two-tone test, the key is instructed by the base station to transmit a certain number of bits at a set frequency deviation after steps (a) and (b). Accordingly, filter circuit 43 is altered in receiver 10 to permit operation of the required new bandwidth of 400 kHz at the correct time. The number of bits and frequency deviations to be transmitted may be sent to the key using an initial message which is triggered by detection and validity testing of the key on the part of the base station. This initial message is encrypted and sent using the low-frequency connection. The timing of the communication is designed so that the relay station is incapable of equalizing or altering the filters at the correct time. Therefore, if data is to be sent with the broader frequency deviation, an interception by a relay station using narrow bandwidth filters of 100 kHz to bypass the two-tone test may be detected at base station 8 because use of the narrow bandwidth filters would introduce data corruption as illustrated in FIG. 4. The corruption represented in FIG. 4 is introduced by a 150 kHz bandwidth filter if a frequency deviation of ±150 kHz is applied to the transmitted data.

In step (d), the two fundamental tones are again transmitted with a channel separation of 100 kHz. The reason is to perform the two-tone test again to detect whether the relay station has widened the bandwidth of any intermediate-frequency filter (IF) used at the relay station. For example, if the bandwidth has now been increased to 400 kHz, the two-tone test which is used at this step will be capable of detecting the presence of the broader bandwidth filter because this would result in mixing of the tones and of the perceptible intermodulation. Period 73 of the tones sent during this message is in turn sent to key 4 during the initial message. This will in turn prevent the relay station from adjusting the filters at the correct time during the communications protocol.

In step (e), the second part of the authentication data is transferred at a frequency deviation of ±200 kHz. This was in turn reported by the base station to the key, so that the security system filters may be adjusted accordingly or switched.

Timing intervals T0, T1, T2, T3 and T4 for each part of the message transmitted by key 4 and optionally the frequency deviations used for transmission of data in data parts (c) and (e) are altered by the base station after each valid detection of key 4. This timing or synchronization data is sent to key 4 with the initial message; parts of the initial message may be transmitted during the transmission of parts of the message by the key, as described above, but are preferably transmitted when key 4 and base station 8 are accommodated together inside the secure area, e.g., after the vehicle has been started. The new synchronization times and deviations are then used for the next communication over the RF interface. Random selection is used for this to prevent relay station 16 from learning the timing and deviations. The frequency deviations for transmission of the high and low bits of the data may be varied according to the capabilities of transmitter 6 and receiver 10 used. For example, the deviation may be as low as ±25 kHz, for example. The bandwidth of the filter used by receiver 10 and the deviation used need only be changed during transmission of the key message to detect the presence of filters used by a relay station 16. If the frequency deviation during the transmission of the data parts goes beyond the bandwidth of the filter of a relay station 16, the data is corrupted by relay station 16 and detected by base station 8. If the filters of the relay station are broad enough that the data is not corrupted, then the two tones are allowed to pass through by the filters and detectable intermodulation products are generated. Even if the relay station is sufficiently well designed to switch intermediate-frequency filters to equalize the change in bandwidth, relay station 16 is unable to ascertain when the filter bandwidth would have to be altered. To be successful, the relay station would have to alter the filter bandwidths at exactly the correct time; otherwise the two-tone test would discover its presence or the data would be corrupted.

The protocol may be varied as a function of the security requirements for the secure area. For example, the power variation between parts (a) and (b) may be omitted and only one two-tone test of a uniform power level used. It is perhaps also possible to make the decision that it is not necessary to subdivide the authentication data into two parts, and that all data in the period is sent following the first two-tone test, thus eliminating the necessity for part (d). If the data is combined in one part, it may be sent with the low-power and high-power two-tone test parts or the two-tone test of the individual uniform power level.

Synchronization is performed starting at the point where key 4 is energized and valid communication is initiated with base station 8. This valid communication may be initiated by the user of the key, as described above.

Those skilled in the art will be aware of a variety of modifications without going beyond the scope of the present invention, as described herein with reference to the accompanying figures.

What is claimed is:

1. A security system (4, 8), including an electronic key (4) having a transmitter (6) and a secure object having a base station (8) which has a receiver (10), the transmitter (6) and the receiver (10) being designed so that they communicate to exchange authentication data, wherein the key (4) transmits the data in a message which includes parts each having predetermined periods (T0, . . . , T4) having transmission signal variations; and the base station (8) detects distortion in the transmission signal variations due to a relay station.

2. The security system according to claim 1, wherein at least one of the parts of this message transmits data having a frequency deviation from a transmission channel frequency to detect corruption of the data due to a filter of a relay station.

3. The security system according to claim 2, wherein the frequency deviation is adjusted together with the bandwidth of the filter circuit.

4. The security system according to claim 1, wherein a filter circuit (43) of the receiver (10) is controlled by the base station (8) to adjust the transmission signal variations for the predetermined periods in synchronization.

5. The security system according to claim 4, wherein the message has a first part having a first period and the filter circuit has a first bandwidth setting for the first period; the message has a second part having a second period to transmit at least a portion of the data with a frequency deviation from a transmission channel frequency, and the filter circuit uses a second bandwidth setting for the second period; and the base station detects corruption of the data due to a filter of the relay station.

6. The security system according to claim 5, wherein a number of the second part, interleaved with the first part, is used to transmit the data.

7. The security system according to claim 5, wherein the first bandwidth setting has a narrower bandwidth than the bandwidth of the frequency deviation of the second bandwidth setting.

8. The security system according to claim 7, wherein the first bandwidth setting has first bandwidths for two tones and for intermodulation products of the tones, and the base station performs a spectral signature test on signals received in the bandwidths to detect a relay station.

9. The security system according to claim 8, wherein the first period includes an initial period having a first transmission signal power and a following period having a second transmission signal power which is different from the first power level.

10. The security system according to claim 8, wherein a number of the second part, interleaved with a first part, is used to transmit the data.

11. The security system according to claim 9, wherein a number of the second part, interleaved with a first part, is used to transmit the data.

12. The security system according to claim 11, wherein only the first (the beginning) of the first part includes the initial period and the following period.

13. The security system according to claim 1, wherein the message has a first part having a first period, and the filter circuit uses a first bandwidth setting for the first period, and the first period includes an initial period having a first transmission signal power and a following period having a second transmission signal power which is different from the first power level.

14. The security system according to claim 13, wherein the message has a first part having a first period, and the filter circuit uses a first bandwidth setting for the first period, and the first bandwidth setting has first bandwidths for each of two tones and for intermodulation products of the tones, and the base station performs a spectral signature test on signals received in the bandwidths to detect a relay station.

15. The security system according to one of claims 1 through 14, wherein the periods are set by the base station and are communicated to the key.

16. The security system according to claim 15, wherein the periods are determined by random selection.

17. The security system according to claim 15, wherein the periods are altered and communicated when the key has been identified as valid.

18. The security system according to claim 15 or 17, wherein the periods are communicated when the key is in the secure object.

19. A vehicle having a security system according to any of claims 1 through 18.

20. A communication method which is implemented by a security system, including an electronic key (4) having a transmitter (6) and a secure object having a base station (8) which has a receiver (10), the method including the transmission of authentication data from the transmitter (6) to the receiver (10), characterized by transmission of data in a message which includes parts each having predetermined periods having transmission signal variations; and detection at the base station (8) of distortion in the transmission signal variations due to a relay station.

21. The communication method according to claim 20, wherein at least one of the parts of this message transmits data having a frequency deviation from a transmission channel frequency to detect corruption of the data due to a filter of a relay station.

22. The communication method according to claim 21, wherein the frequency deviation is adjusted together with the bandwidth of the filter circuit.

23. The communication method according to claim 20, wherein a filter circuit (43) of the receiver (10) is controlled to adjust the transmission signal variations for the predetermined periods in synchronization.

24. The communication method according to claim 23, wherein the message has a first part having a first period and the filter circuit has a first bandwidth setting for the first period; the message has a second part having a second period to transmit at least a portion of the data with a frequency deviation from a transmission channel frequency, and the filter circuit uses a second bandwidth setting for the second period; and the base station detects corruption of the data due to a filter of the relay station.

25. The communication method according to claim 24, wherein a number of the second part, interleaved with the first part, is used to transmit the data.

26. The communication method according to claim 24, wherein the first bandwidth setting has a narrower bandwidth than a bandwidth of the frequency deviation of the second bandwidth setting.

27. The communication method according to claim 26, wherein the first bandwidth setting has first bandwidths for each of two tones and for intermodulation product of the tones, and the base station performs a spectral signature test on signals received in the bandwidths to detect a relay station.

28. The communication method according to claim 27, wherein the first period includes an initial period having a first transmission signal power and a following period having a second transmission signal power which is different from the first power level.

29. The communication method according to claim 27, wherein a number of the second part, interleaved with a first part, is used to transmit the data.

30. The communication method according to claim 28, wherein a number of the second part, interleaved with a first part, is used to transmit the data.

31. The communication method according to claim 30, wherein only the first (the beginning) of the first part includes the initial period and the following period.

32. The communication method according to claim 20, wherein the message has a first part having a first period, and the filter circuit uses a first bandwidth setting for the first period, and the first period includes an initial period having a first transmission signal power and a following period having a second transmission signal power, which is different from the first power level.

33. The communication method according to claim 32, wherein the message has a first part having a first period, and the filter circuit uses a first bandwidth setting for the first period, and the first bandwidth setting has first bandwidths for each of two tones and for intermodulation products of the tones, and the base station performs a spectral signature test on signals received in the bandwidths to detect a relay station.

34. The communication method according to one of claims 20 through 33, wherein the periods are set by the base station and are communicated to the key.

35. The communication method according to claim 34, wherein the periods are determined by random selection.

36. The communication method according to claim 34, wherein the periods are altered and communicated when the key has been identified as valid.

37. The communication method according to claim 34 or 36, wherein the periods are communicated when the key is in the secure object.
